(19) United States
(12) Patent Application Publication
(10) Pub. No.: US 2002/0185770 A1
(43) Pub. Date: Dec. 12, 2002

(54) Method for aligning carbon nanotubes for composites

(76) Inventor: Elbert Lee McKague, Fort Worth, TX (US)

Correspondence Address: James E. Bradley, BRACEWELL & PATTERSON, LLP, P.O. Box 61389, Houston, TX, 77208-1389, US

(21) Appl. No.: 10/164,270

(22) Filed: Jun. 5, 2002

Related U.S. Application Data
(60) Provisional application No. 60/356,312, filed on Feb. 13, 2002.
(60) Provisional application No. 60/296,319, filed on Jun. 6, 2001.

(51) Int. Cl. B82B 3/00

(52) U.S. Cl. 264/108

(57) ABSTRACT

A reinforced polymer is formed by combining a quantity of nano-fibers, preferably carbon nanotubes, with powders of the polymer. The mixture is heated to cause the polymer to fuse to the fibers, forming a feedstock. The feedstock is heated and forced through a die that has channels that change in direction a number of times. Each change in direction results in a high shear stress applied to the feedstock. The shear stress causes the twisted ropes of carbon nanotubes to elongate and align with each other. Rather than a die, sheet rollers may be employed to apply the shear stress.

### CROSS-REFERENCE TO RELATED APPLICATION

This application claims the benefit of the filing date of provisional applications 60/356,312, filed Feb. 13, 2002 and 60/296,319, filed Jun. 6, 2001.

### FIELD OF THE INVENTION

This invention relates in general to a method of producing a polymer reinforced with high aspect ratio nano-fibers, particularly carbon nanotubes, that are collimated.

### DESCRIPTION OF THE PRIOR ART

Carbon nanotubes are molecular scale fibers, on the order of size of DNA, that are composed entirely of carbon atoms arranged in a linked hexagonal pattern. In one form, the nanotubes have multiple walls as represented by a rolled-up sheet of paper or by sheets of paper formed into a tubular shape. In the preferred form, the nanotubes resemble a single sheet hollow tube with a wall thickness of one layer of carbon atoms. Carbon nanotubes, particularly single-wall nanotubes, possess the greatest strength and stiffness of any material that has ever been produced or that can be produced. The strength and stiffness is of enormous potential benefit to the creation of lightweight composite structures made of polymers reinforced with such nanotubes.

Limited availability of nanotubes has slowed composite development. However, even when sufficient lab-scale quantities have been available, several characteristics of carbon nanotubes have prevented combining polymers with adequate amounts of nanotubes to achieve any structural benefits. One of these characteristics is small size. The lengths of tubes have been in the order of 100-200 nanometers and up to one micron, with diameters less than five nanometers. Consequently, there is a very high aspect ratio between the length to the diameter. A greater limitation has resulted from an intrinsic characteristic of carbon nanotubes. The nanotubes clump together, creating rope-like strands that are entwined. These clumping or roping forces are so strong that separation and collimation of the nanotubes has been difficult. Furthermore, the characteristics of the nanotubes are such that polymers into which they are stirred become highly viscous very quickly. This thickening effect causes stiffening of the mixture to a point where no further additions of nanotubes can occur. The limit is reached at concentrations far less than desired to impart attractive structural characteristics to the resulting composite. To help deal with these phenomena, chemical treatments are being developed to impart specific chemical functionality to the nanotubes.

Directional change dies have been used in the past to improve grain structure of metals and improve the properties of certain plastics. A directional change die has one or more channels, each channel having at least one turn or change in direction. Forcing the metal or plastic through the channel is known to result in a change in properties.

### SUMMARY OF THE INVENTION

In this invention, a process of aligning carbon nanotubes, nano-fibers or other nano-scale fibers (referred to herein collectively as “nano-fibers”), comprises combining a quantity of nanofibers with a polymer to create a billet or feedstock. Then, the feedstock is heated and high shear forces are applied to the feedstock, the high shear forces causing alignment and collimation of the nano-fibers.

In one embodiment, the high shear forces are applied with a directional change die that has one or more channels with multiple segments that intersect each other and extend in different directions. The directional change junctions between the segments create shear forces that cause alignment of the nano-fibers to occur. In another application, the polymer and nano-fiber feedstock is forced between a driven roller and an opposing surface, resulting in a reinforced polymer sheet being formed. The shearing action occurs due to the pressure of the rollers against the opposing surface.

In the preferred method of forming the feedstock, finely divided powders of a polymer are mixed with the nano-fibers. Then, heat and optionally pressure are employed to fuse the mixture into the feedstock.

In another manner of creating the feedstock, nano-fibers are blown or otherwise deposited onto a sheet of a polymer. A plurality of the polymer sheets, each with a coating of the nano-fibers, are stacked together then fused to form the feedstock.

### BRIEF DESCRIPTION OF THE DRAWINGS

FIG. 1 illustrates a mixing vessel having nano-fibers and finely divided powders of a polymer therein.

FIG. 2 schematically illustrates a feedstock of mixed nano-fiber and polymer being forced through a die that has two segments extending 90° relative to one another.

FIG. 3 schematically illustrates another die, which has a number of segments that interest each other at 90° angles.

FIG. 4 illustrates a third die that has a number of segment and flow channels that join each other at 135° angles.

FIG. 5 illustrates a reduction die that reduces the diameter of the product being formed by the dies of FIGS. 2-4 into a smaller diameter filament or fiber.

FIG. 6 illustrates a sheet roller applying shear forces to a heated feedstock of nano-fiber and polymer for forming reinforced sheets.

FIG. 7 illustrates a sheet polymer that has been dusted with nano-fibers.

FIG. 8 illustrates a plurality of the sheets of FIG. 7, stacked together and fused to form a feedstock.

FIG. 9 illustrates the feedstock of FIG. 8 being forced into an entry portion of a die 51.

FIG. 10 illustrates the sheets of FIG. 8 being rolled into a cylinder and fused, then being forced into a die.

### DETAILED DESCRIPTION OF THE INVENTION

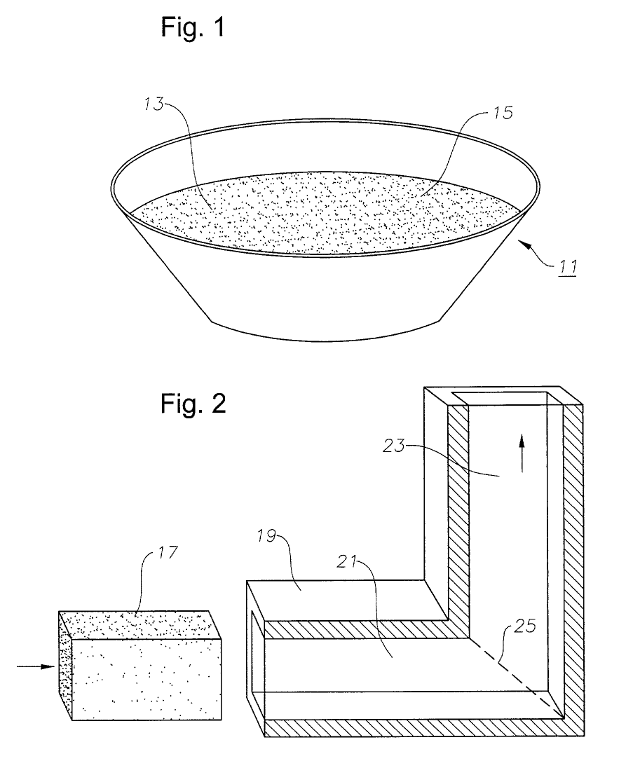

Referring to FIG. 1, vessel 11 represents a conventional mixing vessel for mixing finely divided powders. Vessel 11 has nano-fibers 13 therein, which are preferably single or multi-wall carbon nanotubes. Vessel 11 also has powders of a polymer 15, which may be either a thermoplastic or a thermosetting polymer. Examples of thermoplastic polymers are polyetherimide, nylon, and propylene. Examples of thermosetting polymers are epoxy, cyanate ester, or bismaleimide. If the resulting reinforced polymer is to be in the form of a fiber or filament, preferably thermoplastic polymers are used. Thermosetting polymers may be more suitable for forming sheets of nano-fiber reinforced polymer.

The size of polymer powder 15 is preferably no larger than 150 microns, but preferably even smaller, such as 25 microns. Nano-fibers 13 are in the form of tangled, kinked ropes. The diameters are much smaller than polymer powders 15, being less than 5 nanometers. The lengths may be from about 100-200 nanometers up to one micron. The mixing is performed conventionally such as by tumbling, shaking or stirring. One suitable ratio for nano-fibers 13 to polymer 15 would be with nano-fibers 13 making up 30-70% by weight of the mixture but the ratio could be less, such as 1% to 12% by weight of the mixture comprising nano-fibers 13.

After mixing, the mixture, referred to also as feedstock 17, may be heated to fuse the polymer powders 15 with the nano-fibers 13. The temperature should be approximately the glass transition temperature (“Tg”) of the polymer. The Tg temperature is a published temperature for a variety of polymers and occurs when the polymer is transitioning from a well ordered structure to a more ductile leathery structure. Pressure, such as 100-300 psi, may be required to fuse feedstock 17. The term “feedstock” is used broadly herein as it could encompass many different shapes and sizes as well as being continuous powder material conveyed from the mixing vessel 11 to a die 19. In the embodiment of FIG. 2, feedstock 17 is fused in the shape of a block but it could also be in the shape of a sheet. If a continuous feed of the mixture of polymer powder 15 and nano-fibers 13 to die 19 is employed, fusing before entering die 19 may not be necessary. The fusing will occur in die 19. The term “feedstock” refers to the mixture of polymer powder 15 and nano-fibers 13, whether fused or not before entering die.

Feedstock 17 could also be created without mixing polymer powder 15 with nano-fibers 13. In this alternate technique, a solvent is applied to a suitable polymer to liquefy it. Nanofibers are mixed in the liquefied solvent. Then the solvent is dried or removed to cause the polymer's viscosity to increase.

After feedstock 17 is created by either method, high shear force is then applied to feedstock 17 to align the nano-fibers 13 mixed therein. In the embodiment of FIG. 2, directional change extrusion die 19 causes the shear force. Die 19 has one or more channels extending through it, each channel having at least a first segment 21 and a second segment 23. First segment 21 intersects second segment 23 at a junction 25 that is at least 45 degrees. In this segment 21 and second segment 23 are orthogonal, or intersect each other at an angle of 90 degrees. This results in feedstock 17 having to make a 90 degree left-hand turn as it progresses from first segment 21 to second segment 23. The nano-fibers 13 (FIG. 1) within feedstock 17 prior to entering die 19 will be in tangled ropes in all sorts of directions. As the feedstock 17 turns at junction 25, shear stresses are created, causing the ropes of the nano-fibers 13 to straighten and align or collimate with one another. Typically, there will be a number of segments 21, 23 with most of them making same direction turns in some embodiments; that is, in this case, left-hand turns. The repeated shear stresses result in aligning and collimating nano-fibers 13.

The amount of heat applied as feedstock 17 passes through die 19 is preferably within 50° C. below and 50° C. above the transition temperature Tg of the polymer 15. Also, the force applied by the piston (not shown) to feedstock 17 to push it through die 19 is controlled by a controller. Preferably, the controller controls the piston to achieve a substantially uniform mass flow of feedstock 17 through die 19. The pressures may vary as feedstock 17 passes through die 19. In the embodiment of FIG. 2, the flow areas within channel segments 21 and 23 are the same, although it is not required. If the product exiting from die 19 is to be a fiber or filament, the diameter of each channel might be on the order of 0.0005 to 0.005 inch in diameter If the product exiting die 19 is to be in a sheet form, the channel might have a dimension of 0.005 inch by 50.0 inch wide.

If rather than a thermoplastic polymer, a thermosetting polymer is used, the heat applied to fuse nano-fibers 13 with polymer powders 15 initially should be only sufficient to form a partial cure. Furthermore, the heat applied while passing through die 19 should not be so high as to fully cure the polymer in feedstock 17. Thus feedstock 17 upon exiting die 19 will only be partially cured. It then should undergo a slow heating process to fully cure it.

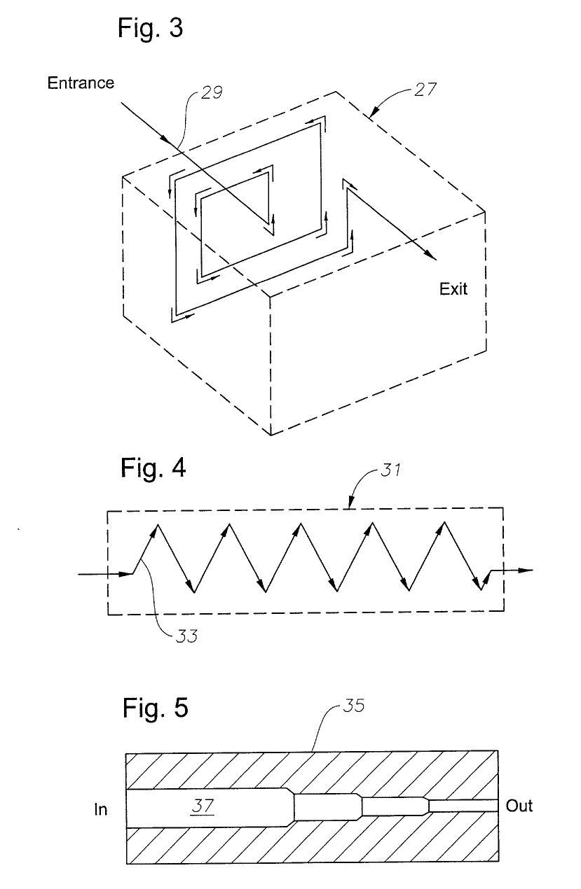

FIG. 3 illustrates schematically a die 27 that has a channel 29 with several 90° turns or corners. As indicated by the arrows in FIG. 3, preferably a majority of the turns turn in the same direction. That is, in the embodiment shown, all of the turns are left-hand turns except for the final one leading to the exit.

FIG. 4 illustrates another die 31. Die 31 has a flow channel 33 that has a number of segments, each intersecting the other at 135°. This results in a change of direction of 135° for the feedstock 17 (FIG. 2) being pushed through channel 33. The turns are not all the same direction in this embodiment, rather alternate between right-hand and left-hand.

After proceeding from one of the dies 19, 27 or 31, it may be desirable to form an elongated fiber or filament of the resulting reinforced polymer. Reduction die 35 of FIG. 5 is preferably incorporated at the exit of one of the dies 19, 27, 31, to successively reduce the reinforced polymer to the desired diameter. Reduction die 35 has a passage 37 through it that successively decreases in diameter to the outlet.

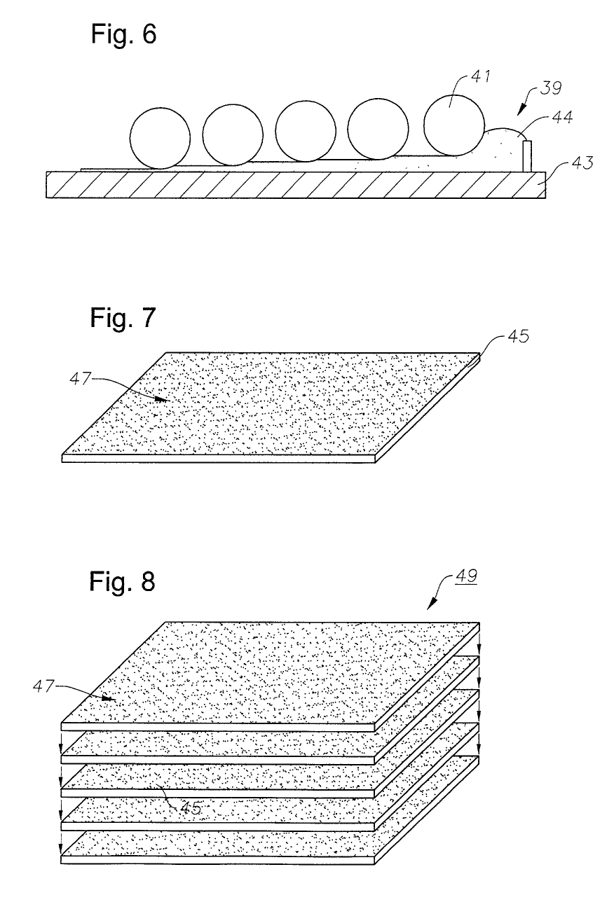

FIG. 6 illustrates another manner of applying high shear stress to the polymer feedstock. Sheet roller 39 has a plurality of driven rollers 41 that are parallel to each other. Rollers 41 are positioned at successively lesser distances above a supporting surface 43, which is shown to be a flat surface. The first roller 41, which is the one on the right side, is spaced a greater distance from supporting surface 43 than the last roller 41 on the left. Feedstock 44 is placed in advance of roller 41, which deforms, shears and presses it into a flat sheet as it passes under the first roller 41 and moves in the direction to the left. Each successive roller 41 will further flatten feedstock 44 into a sheet form. In the shearing process, the nano-fibers therein will align and collimate. Feedstock 44 may be any shape prior to sheet roller 39. The amount of heat applied is approximately the same or somewhat greater than that applied when feedstock is passed through one of the dies 19, 27 or 31.

Another method of applying a high shear force to a polymer mixed with nano-fibers is not illustrated, but involves creating a feedstock 17 in one of the various manners described, but in an elongated rod-like form. Feedstock 17 is then heated to 50 degrees below or above its Tg temperature and drawn through tension rollers. The drawing step greatly reduces the diameter of the rod to a thin fiber or filament that may have a diameter one-hundredth of the diameter of the original rod. The drawing step causes shear forces that align the nano-fibers 15.

Referring to FIG. 7, a different process is utilized for providing a polymer reinforced with nano-fibers. A preformed polymer sheet 45, either cured or partially cured, will be dusted with a layer of nano-fibers 47. Nano-fibers 47 are deposited in a fine layer on the upper surface of sheet 45 by blowing, sprinkling or other means. As shown in FIG. 8, a number of sheets 45, each coated with nano-fibers 47, are stacked together. Then the resulting product is fused with heat and optional pressure, forming a feedstock 49.

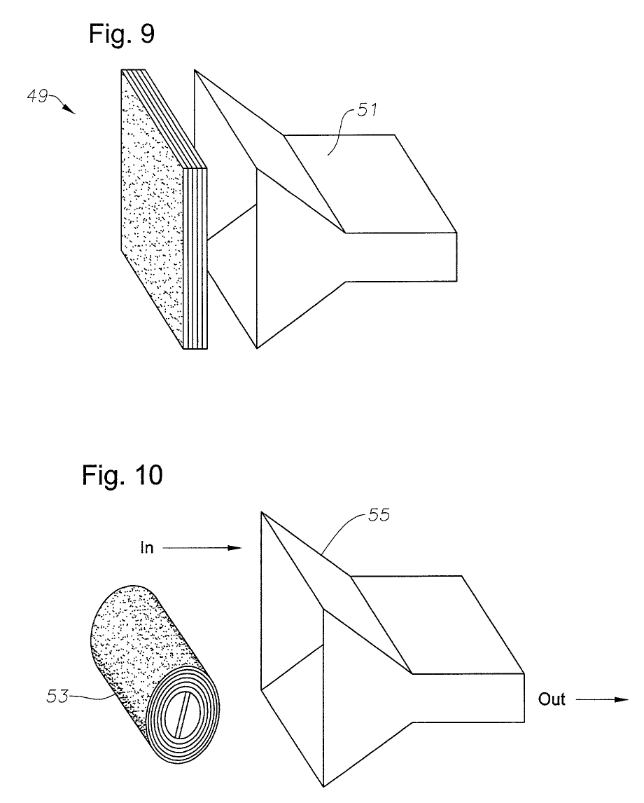

Feedstock 49 may be passed through one of the dies 19, 27 or 31. It may be necessary to have a tapered inlet for die 51 of FIG. 9. The plane of each sheet 45 is orthogonal to the entrance of die 51. The resulting reinforced polymer product could be a fiber, filament or sheet.

In FIG. 10, rather than a rectangular feedstock, a number of the layers 45, each having a nano-fiber 47 coating (FIG. 7), are rolled together and fused to form feedstock 53 in a cylindrical configuration. Feedstock 53 is forced through a die 55 with the axis of the cylinder perpendicular to the entrance channel of die 55. Die 55 may also have a tapered entry. The channels of die 55 may be configured to produce fibers, filaments or sheets.

The reinforced polymer produced as described above may be utilized in a number of manners. The reinforced polymer may be in the form of a fiber that is suitable for braiding or weaving. Alternately, the reinforced polymer may be formed as a sheet. Conventional fibers, such as carbon, graphite, ceramic, glass or polymeric fibers may be pressed into the reinforced polymeric sheet to form a ply for a composite structure. If so, the ratio of nano-fiber to polymer during the mixing process could be even less, say 1 to 5% by weight.

The invention has significant improvements. The resulting polymer is reinforced greatly by the nano-fibers. The methods employed do not require a chemical treatment but chemical treating could be employed in addition, if desired. The high shear flow conditions mechanically force alignment of the carbon nanotubes.

While the invention has been shown in only a few of its forms, it should be apparent to those skilled in the art that it is not so limited but is susceptible to various changes without departing from the scope of the invention.

1. A process of aligning nano-fibers, comprising:
(a) combining a quantity of nano-fibers with a polymer to create a feedstock; then
(b) heating and applying high shear forces to the feedstock, thereby causing alignment of the nano-fibers.

2. The process according to claim 1, wherein step (b) is performed by forcing the feedstock through a die that has a channel with a plurality of segments that extend in different directions, causing the feedstock to change directions at a junction between any two of the segments, thereby creating shear forces that cause alignment of the nano-fibers.

3. The process according to claim 1, wherein step (b) is performed by forcing the feedstock between a driven roller and an opposing surface.

4. The method according to claim 1, wherein step (a) further comprises heating and applying pressure to the nano-fibers and polymer to fuse them together prior to applying the high shear forces.

5. The method according to claim 1, wherein step (a) comprises mixing the polymer in the form of a powder with the nano-fibers to create a mixture, then heating and applying pressure to the mixture to create the feedstock.

6. The method according to claim 1, wherein step (a) comprises depositing the nano-fibers on sheets of the polymer, then stacking the sheets together and applying heat and pressure to form the feedstock.

7. The method according to claim 1, wherein the polymer is a thermoplastic.

8. The method according to claim 1, wherein the polymer is a thermosetting plastic that is in a partially cured state while undergoing step (b), then is subsequently fully cured.

9. The method according to claim 1, wherein in step (b), the feedstock is heated to a temperature that is in the range from 50 degrees C. below to 50 degrees C. above its glass transition temperature.

10. The method according to claim 1, wherein step (a) is performed by applying a solvent to the polymer to liquefy the polymer, then mixing the nano-fibers with the liquefied polymer, then removing the solvent to solidify the polymer.

11. The method according to claim 1, wherein step (b) is performed by drawing the feedstock into a filament.

12. A process of aligning nano-fibers, comprising:
(a) combining a quantity of nano-fibers with a polymer to create a feedstock; then
(b) heating and forcing the feedstock through a die that has a channel that has at least two segments that extend in different directions and join each other at an angular junction, causing the feedstock to change directions at the junction, thereby creating shear forces that cause alignment of the nano-fibers.

13. The method according to claim 12, wherein step (a) further comprises heating and applying pressure to the nano-fibers and polymer to fuse them together in the shape of the feedstock.

14. The method according to claim 12, wherein step (a) comprises mixing the polymer in the form of a powder with the nano-fibers to create a mixture, then heating and applying pressure to the mixture to create the feedstock.

15. The method according to claim 12, wherein step (a) comprises depositing the nano-fibers on sheets of the polymer, then stacking the sheets together and applying heat and pressure to form the feedstock.

16. The method according to claim 15, wherein the sheets are rolled into a cylinder to form the feedstock.

17. The method according to claim 12, wherein in step (b) the feedstock is heated to a temperature that is in the range from 50 degrees C. below to 50 degrees C. below its glass transition temperature.

18. The method according to claim 12, further comprising after step (b) heating and forcing the feedstock through successively smaller passages to create a fiber.

19. The method according to claim 12, wherein step (a) is performed by applying a solvent to the polymer to liquefy the polymer, then mixing the nano-fibers with the liquefied polymer, then removing the solvent to increase the viscosity of the polymer.

20. A process of aligning nano-fibers, comprising:
(a) mixing a quantity of nano-fibers with a powders of a polymer to create a mixture; then
(b) heating the mixture to fuse the powders and the nano-fibers into a feedstock; then
(c) heating and forcing the feedstock through a die that has a channel that has at least two segments that extend in different directions, causing the feedstock to change directions at a junction between the segments, thereby creating shear forces that cause alignment of the nano-fibers.

21. The method according to claim 20, wherein step (a) further comprises applying pressure to the mixture to create the feedstock.

22. The method according to claim 20, wherein the quantity of nano-fibers comprise 12-70 percent by weight of the feedstock.

23. A material consisting essentially of a polymer containing collimated nano-fibers.

24. The material of claim 23, wherein the nano-fibers comprises 12 to 70% by weight of the material.

25. The material of claim 23, wherein the nano-fibers comprise carbon nanotubes.
